(19) United States
(12) Patent Application Publication
(10) Pub. No.: US 2005/0152555 A1
(43) Pub. Date: Jul. 14, 2005

(54) Sound system for model vehicle and/or accessory

(76) Inventor: Martin Pierson, Howell, MI (US)

Correspondence Address: DYKEMA GOSSETT PLLC;Suite 300, 39577 Woodward Avenue, Bloomfield Hills, MI, 48304, US

(21) Appl. No.: 10/893,403

(22) Filed: Jul. 16, 2004

Related U.S. Application Data
(60) Provisional application No. 60/535,868, filed on Jan. 12, 2004.

(51) Int. Cl. H04H 5/00

(52) U.S. Cl. 381/7

(57) ABSTRACT

A sound system for a model vehicle is provided. The sound system includes a control block configured to access predetermined digital data corresponding to a plurality of sound features. The control block is further configured to be responsive to at least one input signal indicative of at least a selected one sound feature to access the predetermined digital data and to generate a sound signal corresponding to the selected sound feature. The sound system further includes a current amplifier responsive to the sound signal configured to drive a speaker to produce the selected sound feature.

### CROSS REFERENCE TO RELATED APPLICATIONS

This application claims the benefit of U.S. Provisional Patent Application No. 60/535,868 filed Jan. 12, 2004, which is hereby incorporated by reference in its entirety.

### BACKGROUND OF THE INVENTION

1. Technical Field

This invention relates generally to electric powered models, for example, model trains. More particularly, the present invention relates to a sound system for model vehicles and/or model vehicle accessories, and a method of producing sound for model vehicles and/or model vehicle accessories.

2. Discussion of the Related Art

Model toy railroads have been in existence, and, generally known, for decades. In a typical model toy railroad layout, the model train engine is an electrical engine that receives power from a voltage that is applied to the tracks and picked up by the train motor. A transformer is used to apply the power to the tracks while contacts on the bottom of the train, or metallic wheels of the train, pick up the applied power for the train motor. The transformer controls both the amplitude and polarity of the voltage, thereby controlling the speed and direction of the train. In HO systems, the voltage is a DC voltage. In O-gauge systems, the track voltage is an AC voltage transformed by the transformer from 60 Hz, 120 volt AC line voltage provided by a standard wall socket, to a reduced AC voltage (e.g., 0-18 volts AC).

Over the course of time, model toy train layouts have adapted to varying degrees of sophisticated electronics to provide improved user control, increased features, and heightened levels of realism, which have converged to improve, generally, user satisfaction.

One basic aspect of model train systems relates to the sound system used to produce prototypical sounds associated with rail trains and real railroad accessories (i.e., railroad crossings). For example, model toy railroad sound systems may be used to produce sounds such as a horn, a bell, a whistle, and a “chuff” sound that corresponds to the speed or load of the train, so as to mimic the sounds produced by real trains. These sound systems can be configured for interaction with the system user such that the user can select whether and when to play a horn sound, for example. These systems can also be configured for automatic sound production without any user involvement, such as in the case of the “chuff” sound.

Conventional sound systems include an amplifier that is run off of the model toy train system voltage source. Accordingly, in a typical model toy railroad system where the train receives its operating power from one of the rails of the track, the amplifier would likewise be powered from the voltage provided by the “power” rail of the track. However, numerous disadvantages exist with these conventional arrangements.

For example, because the track voltage can and does vary, the audio sound level produced by the sound system, which, as stated above is dependent on the train system voltage source, can and does vary as the voltage level varies. Consequently, the quality of the sound and the realism associated with the sound is diminished. To correct this unwanted condition, a voltage regulator positioned between the power source and amplifier is desirable to maintain a constant voltage supply to the sound system amplifier. However, while the addition of a voltage regulator helps to solve the problem of varying voltage levels, it also has its own disadvantages. For example, the voltage regulator required to accept the power levels involved in such an application can be expensive, thus resulting in an increase of overall price being passed on to the consumer.

Accordingly, a need exists for a sound system that minimizes and/or eliminates one or more of the above identified deficiencies.

### SUMMARY OF THE INVENTION

A sound system for a model vehicle is presented. A sound system in accordance with the present invention includes a control block configured to access predetermined digital data corresponding to a plurality of sound features. The control block is responsive to at least one input signal indicative of at least a selected one of the sound features to access the predetermined digital data, and to generate a sound signal corresponding to the selected sound feature. A sound system in accordance with the present invention further includes a current amplifier responsive to the sound signal produced by the control block, and is configured to drive a speaker to produce the selected sound feature.

A method of producing sound for a model vehicle is also presented.

These and other objects and features of this invention will become apparent to one skilled in the art from the following detailed description and accompanying drawings illustrating features of this invention by way of example.

### DESCRIPTION OF DRAWINGS

FIG. 1 is a diagrammatic view of a conventional model toy train system;

FIG. 2 is a schematic and block diagram view of a sound system in accordance with the present invention;

FIG. 3 is a schematic and block diagram view of an exemplary embodiment of the sound system of FIG. 2 in accordance with the present invention;

FIG. 4 is a schematic diagram of the exemplary embodiment of FIG. 3 in accordance with the present invention;

FIG. 5 is a schematic block diagram of an alternate embodiment of the sound system of FIG. 2 in accordance with the present invention;

FIG. 6 is a schematic diagram of the alternate embodiment of FIG. 5 in accordance with the present invention; and

FIG. 7 is a block diagram view of a method of producing sound for a model vehicle and/or model vehicle accessory in accordance with the present invention.

### DETAILED DESCRIPTION OF THE INVENTION

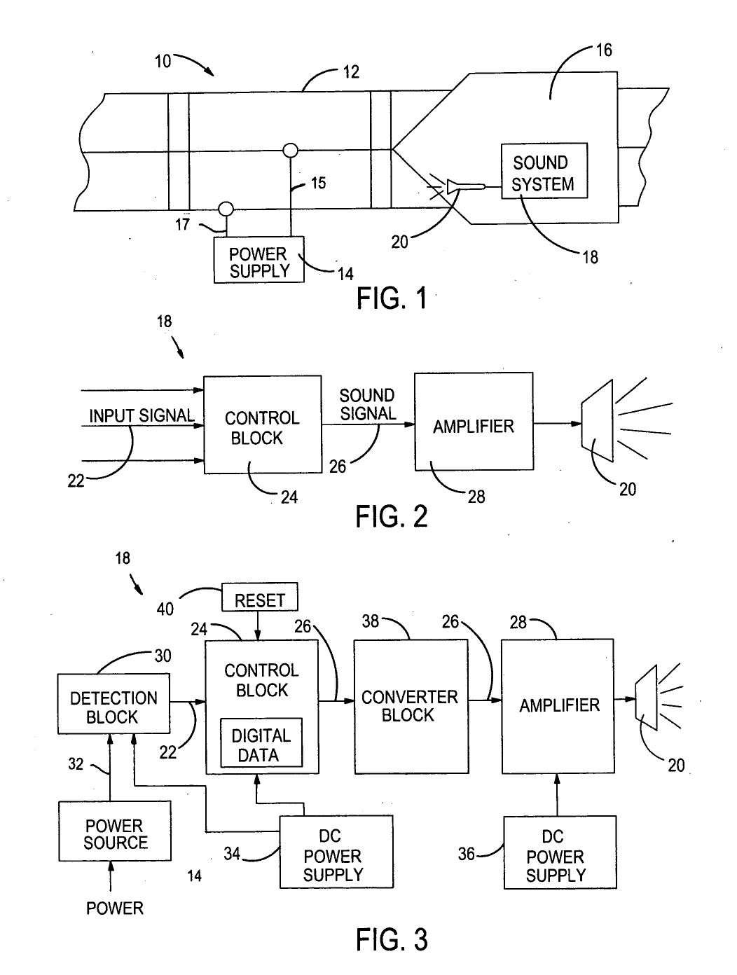

Referring now to the drawings wherein like reference numerals are used to identify identical components in the various views, FIG. 1 depicts a typical model toy railroad layout 10. It should be noted that while a model toy railroad is presented and discussed in depth, the inventive sound system disclosed herein is not limited to such an application. Rather, the sound system and method of producing sound described in detail below can be used with any number of model vehicle systems and accessories for those systems. In an exemplary embodiment, model railroad layout 10 includes a track 12, a power source 14, and a train 16. Track 12 may take the form of a three rail track, as illustrated in FIG. 1. In this embodiment, power source 14 supplies power to track 14 through connectors 15, 17. Connector 15 connects the power terminal of power source 14 to the center rail, or third rail of track 12, and connector 17 connects the ground or common terminal of power source 14 to the outside rail of track 12. Power source 14 can be a conventional AC or DC transformer, depending on the requirements of railroad layout 10, and in particular, model train 16. Additionally, power source 14 may provide a fixed output, a variable output, or both. In one embodiment, railroad layout 10 is an O-gauge layout and power source 14 is an AC transformer which transforms typical AC line voltage (e.g., 120 VAC) to a reduced level (e.g., 0-18 VAC for a conventional O-gauge variable output model train transformer) and supplies the same to track 12.

With continued reference to FIG. 1, model train 16 includes a sound system 18 and a speaker 20, both of which are located onboard train 16. Sound system 18 is configured to control the production of sounds such as, for example, a bell, a horn, a whistle, engine sounds, songs, and other sounds associated with trains and their accessories.

With reference to FIG. 2, in its simplest form, sound system 18 generally includes a control block 24 and a current amplifier 28. Control block 24 is configured to received at least one Input signal 22. Input signal 22 is indicative of at least a selected one of a plurality of sound features, such as, for example, a horn, a bell or a whistle. In response to input signal 22, control block 24 is configured to access predetermined digital data corresponding to the plurality of sound features stored within control block 24. Control block 24 is further configured to generate a sound signal 26 corresponding to the selected sound feature in response to input signal 22, and to transmit sound signal 26 to current amplifier 28. Current amplifier 28, which in a preferred embodiment takes the form of a complimentary symmetry amplifier, is run off of a varying DC supply, as will be discussed below, and is designed for up to several watts of audio power. Current amplifier 28 is configured to receive sound signal 26 and to drive speaker 20 in response to sound signal 26 in order to produce the selected sound feature. Because amplifier 28 is a current amplifier, the audio sound level output from the amplifier is unchanged throughout the variations of voltage. It should be noted, however, that while only a single input signal is depicted in FIG. 2, this arrangement is for illustrative purposes only and is not meant to be limiting in nature. In reality, control block 24 can be configured to receive and process any number of input signals corresponding to a number of different sound features.

With reference to FIG. 3, sound system 18 further includes a detection block 30, a first and a second DC power supply 34, 36, a converter block 38, and a reset circuit 40. In an exemplary embodiment, detection block 30 is electrically connected between power source 14 and control block 24. Detection block 30 is configured to detect a presence of at least one command signal 32 indicative of a selected sound feature, and to transmit command signal 32 to control block 24. In the illustrated embodiment, input signal 22 comprises command signal 32.

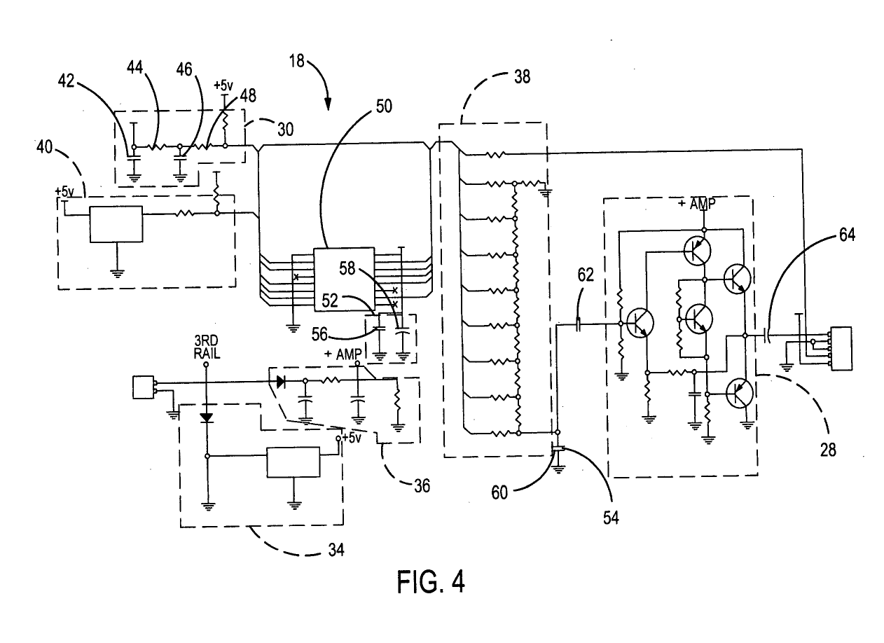

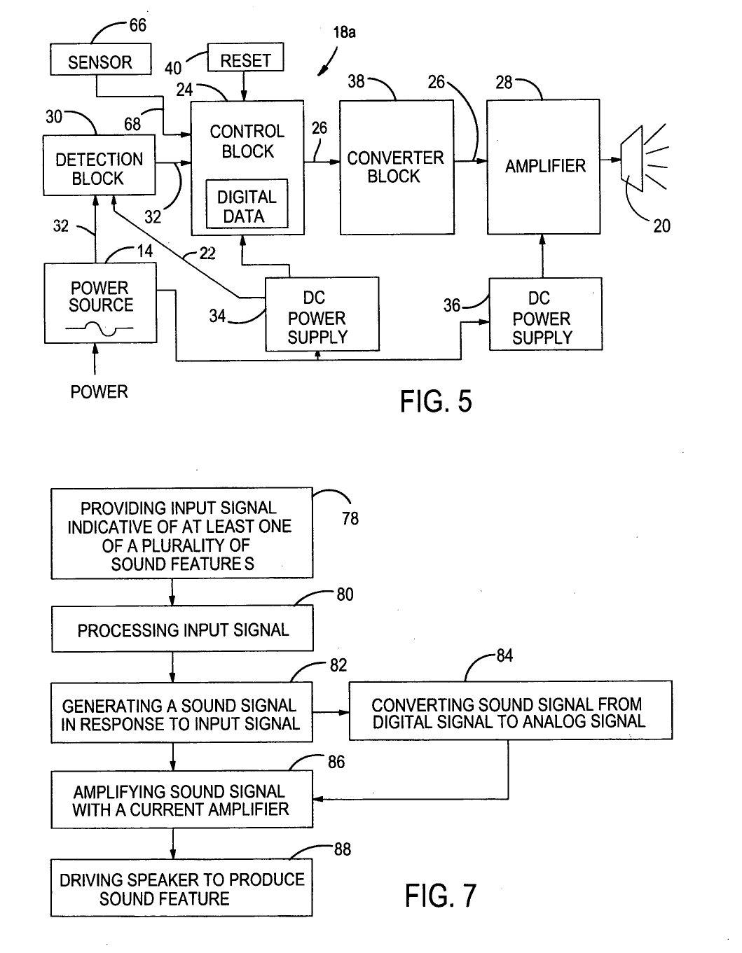

In a preferred embodiment, command signal 32 comprises a DC offset superimposed on the AC voltage signal supplied to track 12 by power source 14. Upon detection of a DC offset by detection block 30, command signal 32 is transmitted to control block 24. This conventional protocol, which is described in great detail in U.S. Pat. Nos. 4,914,431; 5,184,048; and 5,394,068 issued to Severson et al. and hereby incorporated by reference in their entireties, comprises sending positive and negative DC offsets to sound system 18, and control block 24 in particular, located onboard train 16. The different polarities and amplitudes of the DC offsets correspond to different sound features of the train, and accordingly, are each operative to activate at least one of the sound features. In an exemplary embodiment, when a horn sound is selected by the user, a positive DC voltage is produced and superimposed on the AC voltage signal. Similarly, when a bell sound is selected by the user, a negative DC voltage is produced and superimposed on the AC voltage signal. Structurally, detection block 30 comprises (in an exemplary embodiment best shown in FIGS. 4 and 5) a first capacitor 42 connected in series with a first resistor 44, the combination of which is connected in parallel to the combination of a second capacitor 46 connected in series to a second resistor 48. In a preferred embodiment, first capacitor 42 is a 0.22 μF 25V capacitor; second capacitor 46 is a 1 μF 6.3V capacitor; and first and second resistors 44, 48 are 560 kΩ resistors.

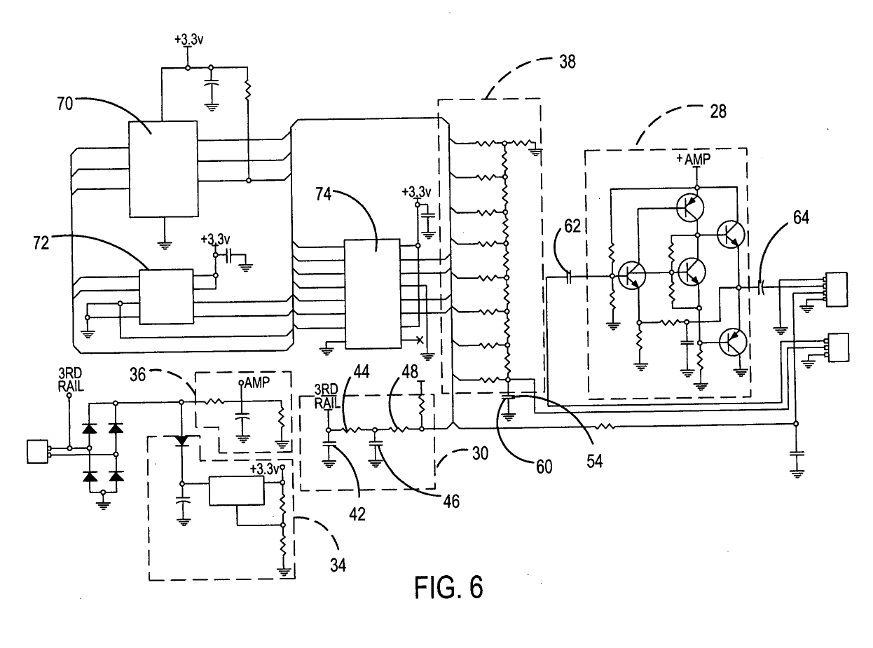

With reference to FIG. 3, and as stated above, sound system 18 further includes first and second DC power supplies 34, 36. First DC power supply 34 is electrically connected to main power source 14 and is configured to provide operating power to both control block 24 and detection block 30. In an exemplary embodiment (i.e., that shown in FIG. 4), DC power supply 34 supplies a voltage of 5V. In an alternate embodiment (i.e., that shown in FIG. 6), DC power supply 34 supplies a voltage of 3.3V. It should be noted, however, that these voltage levels are exemplary only and not limiting in nature. In actuality, DC power supply 34 can produce and supply any DC voltage level within reason. Second DC power supply 36 is likewise connected to main power source 14, however it is configured to provide the necessary operating voltage to current amplifier 28. This configuration allows for a decoupling means to separate the audio power supply from the control block power supply.

With continued reference to FIG. 3, sound system 18 still further includes converter block 38 and reset block 40. Converter block 38 is electrically connected between control block 24 and amplifier 28. Converter block 38 is configured to convert sound signal 26, which is produced as a digital sound signal by control block 24, into an analog sound signal to be provided to current amplifier 28. In an exemplary embodiment, converter block 38 comprises an inexpensive binary ladder digital-to-analog (D/A) converter to carry out this functionality. Reset block 40 is electrically connected to control block 24, and is configured to reset the sound system when needed.

With reference to FIG. 4, an exemplary embodiment of sound system 18 is illustrated. In this embodiment, control block 24 includes a microprocessor unit 50 such as those available from Motorola, Inc., Schaumburg, Ill., under part no. MC68HC908KX8. Microprocessor unit 50 is configured to store the predetermined digital data corresponding to the plurality of sound features, as well as to receive and process input signal 26. In an exemplary embodiment, the predetermined digital data is in the form of standard *.wav format files stored in discrete sections of microprocessor unit 50, however, other formats and compression techniques may be used. Microprocessor unit 50 is further configured to generate sound signal 26 in response to input signal 22. In this exemplary embodiment, microprocessor unit 50 has the capability and capacity to produce sound signal 26 comprised of an approximate one second sound clip that is looped, as known in the art, in order to produce a sustained audio sound. It should be noted, however, that this one second sound clip is provided for exemplary purposes only and is not meant to be limiting in nature. Sound signals may be comprised of sound clips having a lesser or greater duration than one second. Sound system 18 further includes a first filter 52 and a second filter 54. Filter 52 is electrically connected between first DC power supply 34 and microprocessor unit 50 in order to provide a clean 5V supply voltage to microprocessor unit 50. Filter 52 comprises a first capacitor 56 connected in parallel with a second capacitor 58. In a preferred embodiment, capacitor 56 is a 0.1 μF capacitor and capacitor 58 is a 220 μF 6.3V capacitor. Second filter 54, on the other hand, is electrically connected to the output of converter block 38 and is provided to filter out small square wave transitions created by the D/A converter. In an exemplary embodiment, filter 54 comprises a capacitor 60. In a preferred embodiment, capacitor 60 is a 0.1 μF capacitor. Sound system 18 still further includes a first coupling capacitor 62 and a second coupling capacitor 64. In a preferred embodiment, first coupling capacitor 62 is electrically connected between microprocessor unit 50 and amplifier 28, and is a 1 μF 6.3V capacitor. Second coupling capacitor 64, in a preferred embodiment, is connected between amplifier 28 and speaker 20, and is a 220 μF capacitor.

FIG. 5 shows an alternate embodiment of a sound system designated as 18a. Unless stated to the contrary, all disclosure with respect to sound system 18 applies with equal force to sound system 18a.

Sound system 18a, in addition to those features discussed above, further includes a sensor 66 associated with model train 16. Sensor 66 is electrically connected to control block 24 and is configured to monitor or sense an existence or presence of at least one operating condition of vehicle 16, and to also generate an activation signal 68 in response to the existence of the operating condition. In this embodiment, the operating conditions sensed by sensor 66, such as, for example, speed and load, are those that have corresponding sounds associated with them, such as a “chuff”. These sound features are included in the plurality of sound features and corresponding predetermined digital data stored in control block 24. Activation signal 68, therefore, is indicative of the existence of a certain operating condition and sound feature associated with that operating condition.

Accordingly, in this embodiment, control block 24 is configured to access predetermined digital data in response to at least two input signals 22, command signal 32 and activation signal 68, and to generate a sound signal 26 corresponding to the sound features represented by command signal 32 and activation signal 68. This embodiment allows for increased realism as it allows a user to activate various sound features, such as a horn or a bell, while at the same time automatically activating other sound features based on the operating condition(s) of the vehicle, without any user involvement.

With reference to FIG. 6, in a preferred embodiment, control block 24 of sound system 18a includes a microprocessor unit 70, a memory device 72, and a latch device 74. However, it should be noted that while each of these devices is a separate and distinct element, the functionality of each may be carried out using other configurations and arrangements, such as, for example, by using a single device having the capability to perform the functions of all of the elements combined. In a preferred embodiment, microprocessor unit 70, such as those commercially available from Motorola, Inc., Schaumberg, Ill., under part no. MC68HC908QT4, is configured to receive and process command signal 32 and activation signal 68 (best shown in FIG. 5). Microprocessor unit 70 is further configured to generate an output control signal 76 in response to command signal 32 and activation signal 68. Memory device 72, such as those available from Motorola, Inc., Schaumberg, Ill., under part no. M25P40, is configured to store the predetermined digital data corresponding to the plurality of sound features and to generate sound signal 26 in response to output signal 76. In an exemplary embodiment, this predetermined digital data is in the form of standard *.wav format files stored in discrete sections of memory device 74, however, other formats and compression techniques may be used.

In a preferred embodiment, memory device 72 has the capability and capacity to produce sound signal 26 comprised of a several hundred second long sound clip, thereby providing an increased length of sound and alleviating the need of a looping circuit in order to produce a sustained audio sound. Once sound signal 26 is generated by memory device 72, it is transmitted to latch device 74. Latch device 74, such as those known in the art, is configured to receive sound signal 26 and convert sound signal 26 from a serial sound signal to a parallel sound signal. Once this conversion is complete, converted sound signal 26 is transmitted from latch device 74 to converter block 38 for conversion from a digital signal to an analog signal, and then onto current amplifier 28 where the sound feature is ultimately produced.

With reference to FIG. 7, a method of producing sound for a model vehicle is shown. Step 78 includes providing at least one input signal indicative of at least one of a plurality of sound features corresponding to the model vehicle. The input signal may be a command signal corresponding to a system user's selection of a particular sound feature, an activation signal corresponding to an operating condition of the vehicle, or both.

Step 80 includes processing the input signal, and step 82 includes generating a sound signal in response to the input signal. The combination of steps 80 and 82 include accessing portions of predetermined digital data stored in the control electronics of the vehicle that correspond to the selected or designated sound features, and then generating a sound signal representative of these selected or designated sound features.

Step 84 includes converting the sound signal generated in step 82 from a sound signal existing as a digital sound signal to a sound signal existing as an analog sound signal. Step 86 and step 88 then respectively include amplifying this analog sound signal using a current amplifier, such as a complimentary symmetry amplifier, and then driving a speaker to produce the appropriate sound features corresponding to the sound signal.

Accordingly, in operation, for example, a model vehicle system user, such as a model train railroader, selects one of a plurality of sound features, such as for example, a horn. A command signal corresponding to the horn sound is generated and transmitted to the control block. The control block receives this input, processes it and accesses portions of predetermined digital data stored in the control block that corresponds to the selected horn sound. The control block then generates a sound signal representative of the horn sound and transmits the signal to a converter block where it is converted from a digital sound signal to an analog sound signal. This converted sound signal is then transmitted to a current amplifier which drives a speaker to produce the selected horn sound.

In another example, in addition to the production of the horn sound, for example, a sensor associated with the model vehicle, such as a train, is provided and configured to sense one of a plurality of operating conditions of the train, such as, for example, the speed of the train. The sensor is configured to generate an activation signal corresponding to the speed of the train which is transmitted to the control block. The control block receives this input, processes it, and then accesses the portions of the predetermined digital data stored in the control block that corresponds to the sensed speed of the train, i.e., the “chuff” sound. The control block then generates a sound signal corresponding to the “chuff” sound related to the sensed speed and outputs the sound signal to the converter block. The converter block then converts the signal from a digital signal to an analog signal, and transmits the converted signal to the current amplifier which drives the speaker to produce the “chuff” sound.

The benefits provided by the sound system described above are numerous. These benefits include, but are not limited to, providing for an increased quality of sound, as the amplifier is no longer dependent on the voltage level but rather is current amplifier, while at the same time avoiding costly circuitry, such as a voltage regulator, to achieve this benefit.

It should be noted that while only those embodiments set forth above have been described in detail, other configurations and embodiments for the present invention exist that are within the spirit and scope of the invention.

1. A sound system for a model vehicle, comprising:
a control block configured to access predetermined digital data corresponding to a plurality of sound features, said control block being responsive to at least one input signal indicative of at least a selected one of said sound features to access said predetermined digital data and to generate a sound signal corresponding to said selected sound feature; and
a current amplifier responsive to said sound signal configured to drive a speaker to produce said selected sound feature.

2. A sound system in accordance with claim 1 further comprising:
a main power source; and
a detection block electrically connected between said main power source and said control block wherein said detection block is configured to detect a presence of at least one command signal indicative of said selected sound feature, and further wherein said input signal comprises said command signal.

3. A sound system in accordance with claim 2 wherein said main power source is an AC power source configured to provide an AC voltage signal.

4. A sound system in accordance with claim 3 wherein said command signal comprises a DC-offset superimposed on said AC voltage signal.

5. A sound system in accordance with claim 2 further comprising a DC-power supply electrically connected to said main power source wherein said power supply is configured to provide operating power to said detection block and said control block.

6. A sound system in accordance with claim 5 wherein said power supply comprises a 5-volt power supply.

7. A sound system in accordance with claim 5 wherein said power supply comprises a 3.3-volt power supply.

8. A sound system in accordance with claim 2 further comprising a DC-power supply electrically connected to said main power source wherein said power source is configured to provide operating power to said current amplifier.

9. A sound system in accordance with claim 1 further comprising a converter block electrically connected to said control block configured to convert said sound signal existing as a digital sound signal into a sound signal existing as an analog sound signal.

10. A sound system in accordance with claim 9 wherein said converter block includes a binary ladder digital-to-analog (D/A) converter.

11. A sound system in accordance with claim 1 further comprising a reset block electrically connected to said control block.

12. A sound system in accordance with claim 1 wherein said control block includes a microprocessor unit configured to store said predetermined digital data and further configured to receive and process said input signal and to generate said sound signal.

13. A sound system in accordance with claim 1 wherein said control block includes:
a microprocessor unit configured to receive and process said input signal and to generate an output control signal in response to said input signal;
a memory device configured to store said predetermined digital data and operative to receive said output control signal and to generate said sound signal in response to said output control signal; and
a latch device configured to receive said sound signal and to convert said sound signal from a sound signal existing as a serial sound signal to a sound signal existing as a parallel sound signal.

14. A sound system in accordance with claim 1 wherein said plurality of sound features include at least sounds corresponding to a bell, a whistle, a horn and a chuff sound.

15. A sound system in accordance with claim 1 further comprising a sensor associated with said model vehicle configured to sense at least one of a plurality of operating conditions of said vehicle, said sensor being electrically connected to said control block and operative to generate an activation signal indicative of at least one sound feature corresponding to said at least one operating condition of said vehicle, wherein said input signal comprises said activation signal.

16. A sound system in accordance with claim 1 wherein said current amplifier comprises a complimentary symmetry audio power amplifier.

17. A sound system in accordance with claim 1 wherein said sound system further includes:
a first coupling capacitor connected between said control block and said amplifier;
a speaker connected to an output of said amplifier; and
a second coupling capacitor connected between said output of said amplifier and said speaker.

18. A sound system for a model vehicle, comprising:
a main power source;
a control block configured to access predetermined digital data corresponding to a plurality of sound features and being responsive to at least a command signal indicative of a selected one of said plurality of sound features and an activation signal indicative of an associated one of said plurality of sound features corresponding to a presence of at least one operating condition of said model vehicle to access said predetermined digital data and to generate a sound signal corresponding to said command signal and said activation signal;
a detection block electrically connected between said main power source and said control block configured to detect a presence of said command signal;
a sensor associated with said model vehicle electrically connected to said control block configured to sense said presence of said operating condition of said vehicle, and being operative to generate said activation signal indicative of said associated sound feature in response to said operating condition;
a current amplifier connected to said control block responsive to said sound signal configured to drive a speaker to produce said sound feature, said amplifier comprising a complimentary symmetry audio amplifier.

19. A sound system in accordance with claim 18 further comprising a converter block electrically connected to said control block configured to convert said sound signal existing as a digital sound signal into a sound signal existing as an analog sound signal.

20. A sound system in accordance with claim 19 wherein said converter block includes a binary ladder digital-to-analog (D/A) converter.

21. A sound system in accordance with claim 18 further comprising a DC-power supply electrically connected to said main power source wherein said power supply is configured to provide operating power to said detection block and said control block.

22. A sound system in accordance with claim 21 wherein said power supply comprises a 5-volt power supply.

23. A sound system in accordance with claim 21 wherein said power supply comprises a 3.3-volt power supply.

24. A sound system in accordance with claim 18 further comprising a DC-power supply electrically connected to said main power source wherein said power source is configured to provide operating power to said amplifier.

25. A sound system in accordance with claim 18 further comprising a reset block electrically connected to said control block.

26. A sound system in accordance with claim 18 wherein said main power source is an AC power source configured to provide an AC voltage signal.

27. A sound system in accordance with claim 26 wherein said command signal comprises a DC-offset superimposed on said AC voltage signal.

28. A sound system in accordance with claim 18 wherein said control block includes a microprocessor unit configured to store said predetermined digital data and further configured to receive and process said command signal and said activation signal to generate said sound signal.

29. A sound system in accordance with claim 18 wherein said plurality of sound features include at least sounds corresponding to a bell, a whistle, a horn and a chuff sound.

30. A sound system in accordance with claim 18 wherein said control block includes:
a microprocessor unit configured to receive and process said command signal and said activation signal and to generate an output control signal in response to said command signal and activation signal;
a memory device configured to store said predetermined digital data and operative to receive said output control signal and to generate said sound signal in response to said output control signal; and
a latch device configured to receive said sound signal and to convert said sound signal existing as a serial sound signal to a sound signal existing as a parallel sound signal.

31. A sound system in accordance with claim 18 wherein said amplifier further includes:
a first coupling capacitor connected between said control block and said amplifier;
a speaker connected to an output of said amplifier; and
a second coupling capacitor connected between said output of said amplifier and said speaker.

32. A method of producing sound for a model vehicle comprising the steps of:
providing at least one input signal indicative of at least one of a plurality of sound features;
processing said input signal;
generating a sound signal in response to said input signal corresponding to said sound feature;
amplifying said sound signal with a current amplifier; and
driving a speaker to produce said sound feature.

33. A method in accordance with claim 32 further including the step of converting said sound signal existing as a digital sound signal to a sound signal existing as an analog sound signal.
